(19) United States
(12) Patent Application Publication
(10) Pub. No.: US 2024/0189710 A1
(43) Pub. Date: Jun. 13, 2024

(54) METHOD OF USING PHYSICAL MOVEMENT FOR VIRTUAL GAMEPLAY CONTROL AND ASSOCIATED APPARATUS

(71) Applicant: 2354561 Alberta Ltd., Calgary (CA)

(72) Inventors: Geoffrey Samuel FROST, Calgary (CA); Stephen KIM, Pickering (CA); Nabil BABU, Toronto (CA); Adam COLLVER, Guelph (CA); Andre DAVIAU, Toronto (CA)

(21) Appl. No.: 18/533,255

(22) Filed: Dec. 8, 2023

Related U.S. Application Data
(60) Provisional application No. 63/431,246, filed on Dec. 8, 2022.

(51) Int. Cl. A63F 13/428; A63F 13/213

(52) U.S. Cl. CPC A63F 13/428; A63F 13/213; A63F 13/816

(57) ABSTRACT

A method and apparatus for using physical movement, e.g. associated with a physical therapy, for virtual gameplay control. A selection of an exercise is received from a user interface. After the selection, data associated with the exercise can be read from memory. The data includes a plurality of joints to detect and expected positions of each of the joints. A plurality of frames of a performance of a user performing the exercise are received, from sensors such as a video camera. Each of the joints within each of the frames can be detected, and a change in positions of joints can be determined. Subsequently, an indication of success that the exercise was performed correctly is sent to the user interface. A character in the game then takes an action, thus in this manner, the user can reliably control their character's in-game actions.

### CROSS-REFERENCE TO RELATED APPLICATIONS

This application claims the benefit of priority to U.S. provisional patent application Ser. No. 63/431,246 entitled “METHOD OF USING PHYSICAL MOVEMENT TO VIRTUAL GAMEPLAY CONTROL METHOD” filed Dec. 8, 2022, hereby incorporated by reference in its entirety.

### FIELD OF THE INVENTION

The present invention pertains to the field of digital therapeutics and in particular to methods, apparatus and systems for using physical movement for virtual gameplay control.

### BACKGROUND

Currently in the field of rehabilitation medicine, patients diagnosed with musculoskeletal injuries and pathologies are able to recover by participating in a therapeutic exercise program suggested by a health care professional or clinician based on their physical limitations and health conditions. Therapeutic exercise programs typically start with a few sessions with a physiotherapist, and then these participants are expected to continue their therapeutic exercise program at home on their own time. However, patients often do not comply with treatment regimes of therapeutic exercise. Research has shown that the reasons for non-compliance are diverse, which include a low adherence rate to therapeutic exercise programs (i.e., not enough exercise is completed during recovery from musculoskeletal injuries). This leads to inadequate treatment for musculoskeletal injuries, which is often referred to as the adherence gap in musculoskeletal medicine.

Furthermore, the current way of participating in a therapeutic exercise program can be cost prohibitive for some patients, and some patients may not be able to attend physiotherapy due to either time constraints (only open during mandatory working times) or distance constraints (too far away). In other words, there may be cost barriers to centre-based therapeutic exercise programs, time constraints of therapeutic exercise programs, or location constraints to therapeutic exercise programs.

Therefore, there is a need for methods and systems that obviate or mitigate one or more limitations of the prior art, for example, increasing adherence to a therapeutic exercise plan, and increasing accessibility to therapeutic exercise by decreasing costs, by eliminating time restrictions on participation and by eliminating geographic constraints on participation.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present disclosure is to provide a method, a system, and computer readable medium for using successful completion of physical movements for virtual gameplay control leading to increased adherence to a therapeutic exercise program.

In accordance with an aspect of the present disclosure, there is provided a method for assessing the performance of an exercise. The method includes multiple steps as performed by a computer. First, it includes receiving a selection of an exercise from a user interface for the computer. After the selection of the exercises is received from the user interface, data associated with the exercise can be read from a non-transitory computer memory. The data includes indications of a plurality of joints to detect and a plurality of expected positions of each of the plurality of joints. The joints may be physical skeletal joints of the user, for example. The method further includes receiving a plurality of frames of a performance of a user performing the exercise, from a video source. Each of the plurality of joints within each of the plurality of frames can be detected, and a change in positions of each of the plurality of joints over a timeframe corresponding to (e.g. spanning) the plurality of frames can be determined. Subsequently, an indication of success that the exercise was performed correctly is sent to the user interface.

In embodiments, in response to sending the indication of success, a movement of a character of a computer game can be displayed on the user interface, and the movement of the character may include moving the character between horizontal lanes displayed in the computer game.

Furthermore, in embodiments, objects may be displayed on the user interface, and these objects within the lanes of the computer game can prompt the user to perform the exercise, in order to move the character into a lane or out of a lane through a successful performance of the exercise.

In accordance with another aspect of the present disclosure, there is provided a computing system configured to carry out a method as defined in any one of aforementioned methods. The system includes a processor and a tangible, non-transitory computer readable medium. The computer readable medium includes instructions recorded thereon to be performed by the processor of the system to carry out a method as defined in any one of aforementioned methods. The system may further include a user interface, one or more motion capture devices such as video cameras or other sensors, or a combination thereof.

In accordance with another aspect of the present disclosure, there is provided a tangible, non-transitory computer readable medium having instructions recorded thereon to be performed by a processor to carry out a method as defined in any one of aforementioned methods.

Embodiments have been described above in conjunctions with aspects of the present disclosure upon which they can be implemented. Those skilled in the art may appreciate that embodiments may be implemented in conjunction with the aspect with which they are described but may also be implemented with other embodiments of that aspect. When embodiments are mutually exclusive, or are otherwise incompatible with each other, it may be apparent to those skilled in the art. Some embodiments may be described in relation to one aspect, but may also be applicable to other aspects, as may be apparent to those of skill in the art.

### BRIEF DESCRIPTION OF THE FIGURES

Further features and advantages of the present disclosure may become apparent from the following detailed description, taken in combination with the appended drawings, in which;

FIG. 1 illustrates a system for using physical movement for virtual gameplay control method, according to an embodiment.

FIG. 2 illustrates a method of using physical movement for virtual gameplay control method, according to an embodiment.

FIG. 3 illustrates a user interface showing movement of a gameplay character, according to an embodiment.

FIG. 4 illustrates an exercise gameplay loop, according to an embodiment.

FIG. 5 illustrates an electronic device, according to an embodiment.

It may be noted that throughout the appended drawings, like features are identified by like reference numerals.

### DETAILED DESCRIPTION OF THE INVENTION

Unless defined otherwise, all technical and scientific terms used herein have the same meaning as commonly understood by one of ordinary skill in the art to which this invention belongs.

In relation to the present disclosure, the terms “user,” “patient”, “player”, and “participant” may be used interchangeably.

In accordance with an aspect of the present disclosure, there is provided a method for assessing the performance of an exercise. The method includes multiple steps. First, it includes receiving a selection of an exercise from a user interface. After the selection of the exercises is received from the user interface, data associated with the exercise can be read from a non-transitory memory. The data includes a plurality of joints to detect and a plurality of expected positions of each of the plurality of joints. The method further includes receiving a plurality of frames of a performance of a user performing the exercise, from a video source. The frames may be digital photographs or still frames extracted from a digital video stream, for example. Each of the plurality of joints within each of the plurality of frames can be detected, and a change in positions of each of the plurality of joints over a timeframe corresponding to the plurality of frames can be determined. That is, the timeframe spans and is approximately equal to the interval of time starting when the first frame was obtained and ending when the last frame was obtained. Subsequently, an indication of success that the exercise was performed correctly is sent to the user interface.

The frames can be processed to compare the detected positions of the joints to the expected positions of the joints, corresponding to successfully carrying out the exercise. Successfully carrying out of the exercise may be determined when the detected positions and expected positions match spatially and temporally, within predetermined tolerance bounds.

In embodiments, the plurality of expected positions of each of the plurality of joints includes relative positions between the plurality of expected positions of two of the plurality of joints.

In embodiments, the comparing of the changes in positions of each of the plurality of joints to the plurality of expected positions of each of the plurality of joints over the timeframe includes comparing relative starting positions of each of the plurality of joints to relative ending positions of each of the plurality of joints.

In embodiments, in response to sending the indication of success, a movement of a character of a computer game can be displayed on the user interface.

In embodiments, the movement of the character includes moving the character between horizontal lanes displayed in the computer game. Additionally or alternatively, the computer game may involve other types of gameplay. The gameplay may involve working toward a particular goal such as reaching a destination, avoiding a threat, finding an item, entering a more desirable state, etc.

In embodiments, objects may be displayed on the user interface, and these objects within the lanes of the computer game can prompt the user to perform the exercise, in order to move the character into a lane or out of a lane through a successful performance of the exercise.

In embodiments, the plurality of joints to detect are selected from the group including a wrist, an elbow, and a shoulder.

In embodiments, movement of each of the plurality of joints includes a flexion movement or a rotational movement.

In accordance with another aspect of the present disclosure, there is provided a computing system configured to carry out a method as defined in any one of aforementioned methods. The system includes a processor and a tangible, non-transitory computer readable medium. The computer readable medium includes instructions recorded thereon to be performed by the processor of the system to carry out a method as defined in any one of aforementioned methods.

In accordance with another aspect of the present disclosure, there is provided a tangible, non-transitory computer readable medium having instructions recorded thereon to be performed by a processor to carry out a method as defined in any one of aforementioned methods.

In some embodiments, determining that the performance was a success is based on information preloaded into the non-transitory memory.

In some embodiments, the exercise includes elbow flexion or shoulder rotation. Additionally or alternatively, the exercise may include other joints and associated motions.

The computing system may be partially or fully co-located with the user, user interface and video source. The computing system performing the processing may be remote from the user (e.g. on a remote server or data center or other virtualized resource) and operatively coupled to the user interface and video source via a communication link.

The disclosure may now be described with reference to specific examples. It may be understood that the following examples are intended to describe embodiments of the invention and are not intended to limit the invention in any way.

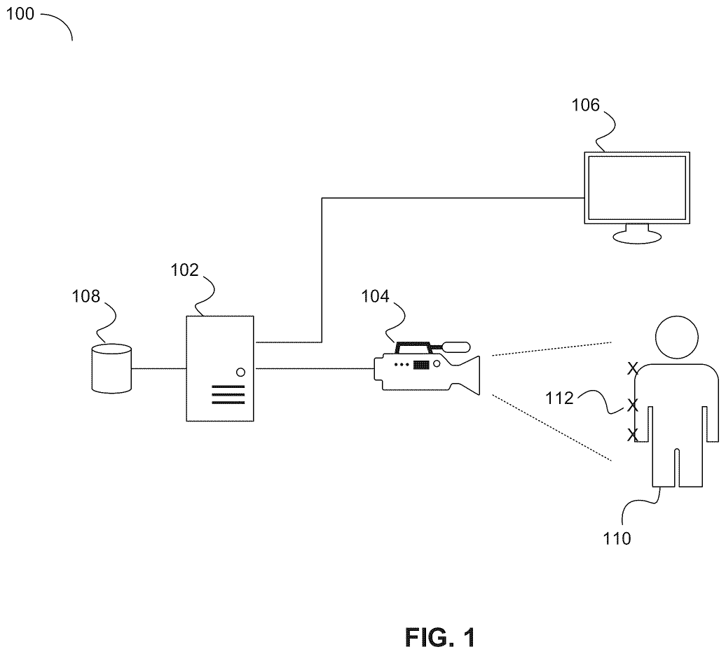

FIG. 1 illustrates a system for using physical movement required for a therapeutic exercise for a virtual gameplay control method, according to an embodiment of the present disclosure. Referring to FIG. 1, the computing system 100 uses a computer system (including a motion capture software) 102 and a video source 104 to track the real-world movement of the player or participant 110. The video source 104 can be a forward-facing camera or another video capture device. The computer system (executing motion capture software) 102 can be operatively coupled to a non-transitory memory (e.g., a storage database) 108. The data captured by the camera 104 can be transmitted to the motion capture software 102 and further transmitted to the storage database 108 or similar computer storage device. The motion capture software 102 is also operatively coupled with a user interface 106 that may include a video display, speaker, or other user interface output device as is known in the art. In use, the participant 110 performs the actions of the therapeutic exercise while the video source 104 captures their movements. The motion capture software extracts the positions of joints (as indicated by “X” 112 in FIG. 1) to be used to determine if the exercise has been performed properly. The video source 104 can be integrated with or separate from the user interface 106. As examples, a mobile device, laptop, gaming system, or other electronic system can be used to supply one or more of the video source, user interface, and computer system 102. If required, multiple video sources can be used to obtain images from multiple angles for improved video capture.

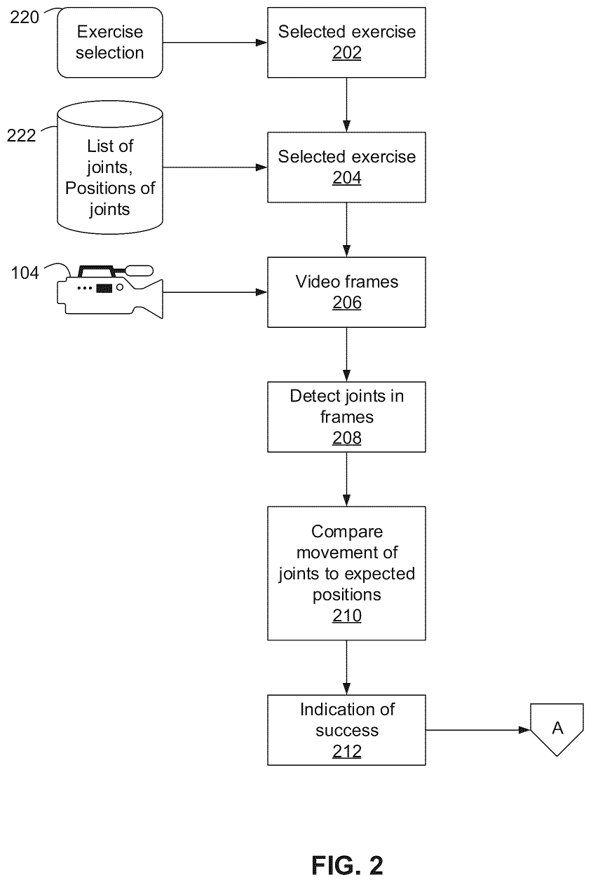

FIG. 2 illustrates a method of using physical movement generated from the performance of a therapeutic exercises for virtual gameplay control, according to an embodiment of the present disclosure. Referring to FIG. 2, the method involves multiple steps. At step 220, a health care professional or clinician suggests an appropriate therapeutic exercise regime for the player 110 based on his or her individual physical limitations and health conditions, and further interacts with the game system 100 to input the suggested therapeutic exercises for the player 110. Furthermore, at step 222, the data (including a plurality of joints to detect and a plurality of expected positions of each of the plurality of joints) are stored into the storage database 108.

After opening or launching the game (i.e., embedded or installed in the system 100), at step 202, the player 110 is prompted to select an exercise from a list of available exercises (as suggested by the clinician at step 220). Each exercise may include information or parameters 222, including a list of joints, such as a wrist, elbow, or a shoulder, and positions of the listed joints. Positions may include start and end positions and may be expressed as movements. Movements can be of a variety of types including flexion movements or rotational movements. The information 222 may also include timelines, time limits, or other game parameters. At step 204, information 222 including the relevant joints and expected positions of the joints from step 222 are mapped to the gameplay so that the positions of the player's cardinal body joints in the real world are established. Step 204 may include a calibration process (not shown in FIG. 2). The participant 110 is prompted to calibrate the camera 104 so that motion capture software 102 works adequately. This involves moving the camera 104, moving the player's 110 own position with respect to the camera 104. It may also involve adjusting lighting so that the player's 110 body is clearly distinguishable from the background. The game may prompt the player 110 to make changes until the requisite conditions for adequate motion capture have been achieved. The requisite conditions are based on reading data associated with the exercise from the storage database 108. For example, the calibration relating to the left elbow can include horizontally straightening the player's left elbow with palm open and fingers pointing away from body, with respect to the expected positions of the left elbow.

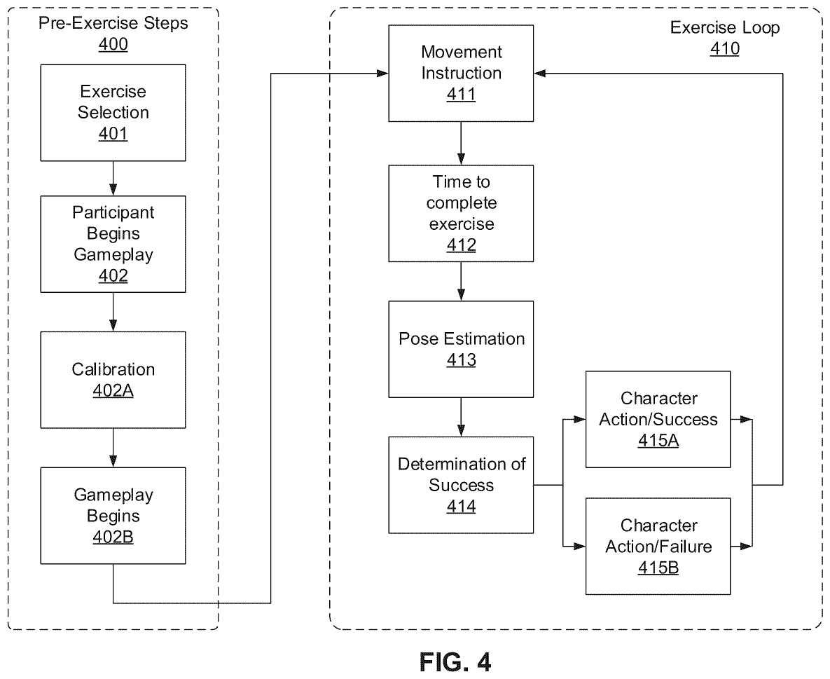

After the calibration process, the player 110 can begin the gameplay (e.g., entering the exercise gameplay loop). Notably, the gameplay loop can be a multi-step process that determines the player's progress in the game (as illustrated in FIG. 4).

During the exercise gameplay loop, the player's 110 physical movement is then tracked over time. At step 206, a plurality of frames of a performance of a player 110 performing the exercise is captured or received by a video source (e.g., camera) 104. At step 208, each of the plurality of joints within each of the plurality of frames are detected. At step 210, positions of the joints over a timeframe corresponding to the frames are compared to expected positions of the joints. At step 212, if the player's movement corresponds with a suggested therapeutic exercise, the movement is judged a success and then the indication of success that the exercise was performed correctly is sent to a user interface 106. The player's character in the game then takes an action. The in-game action is tied to the specific movement carried out by the player. In this manner, the player can reliably control their character's in-game actions.

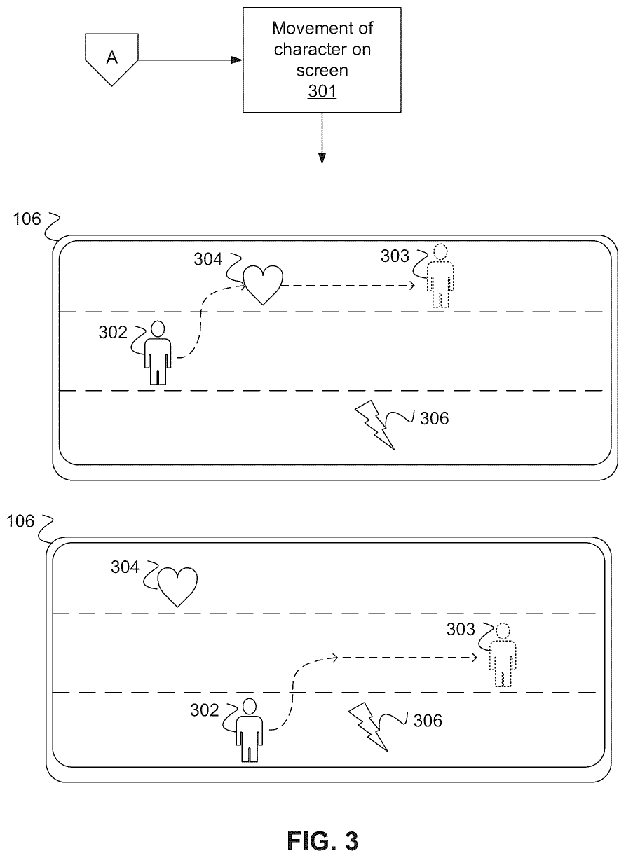

FIG. 3 illustrates a user interface showing movement of a gameplay character, in accordance with an embodiment of the present disclosure. Referring to FIG. 3, at step 301, the user interface 106 displays movement of the gameplay character on its screen (e.g., between three horizontal lanes), depending on whether the physical movement of the player's 110 joints captured by the camera 104 meets the expected positions of joints, indicating successfully performing the exercise. On the user interface 106, objects within the game lanes may prompt the player 110 to perform the exercise in order to move the character between different lanes of the game. For example, if the player sees a good object 304 such as heart or prize, the player may try to move the game character to an end position 303, touching the good object 304 in time by successfully performing the therapeutic exercise. Similarly, if the player sees a bad object 306 such as lighting or banana peel, the player may try to move the game character to an end position 303, avoiding the bad object 306 in time also by successfully performing the therapeutic exercise. Failure in performing the therapeutic exercise successfully may result in losing the good object 304 or running into the bad object 306. In some embodiments, successful performance of the exercise (e.g., player's physical movement meets expectation) results in moving the game character 302 from its current lane (e.g., the middle lane) into an expected lane with good object symbols 304 such as heart or prize (e.g., the upper lane). In some embodiments, the failed performance of the exercise (e.g., player's physical movement does not meet expectation) results in moving the game character 302 out of its current lane into an expected lane with bad object symbols 306 such as lighting or banana peel (e.g., the bottom lane). In other embodiments, the failed performance of the exercise (e.g., player's physical movement does not meet expectation) results in maintaining the game character 302 in its current lane. The corresponding movements of gameplay characters are pre-set or programmed in the system, and can be updated or changed at any time (e.g., by the game provider).

The game (and screen) may update at particular intervals, and thus gameplay may proceed at a particular rate. The update intervals and gameplay rate may depend for example on a desired frequency at which the user should perform exercises, as input by a health care professional for example. For example, the game may update daily, several times a day, hourly, several times an hour, every few minutes, every multiple of seconds, etc. The game may update at different rates at different times, for example the game may update every second for a certain period, such as a few minutes, and then may refrain from updating for a longer period, such as a day. The user may or may not be provided with an option to accumulate motion credits during periods where the game is not updating. Motion credits may be spent to move the character the next time the game is updating.

FIG. 4 illustrates an exercise gameplay loop, in accordance with an embodiment of the present disclosure.

Referring to FIG. 4, the pre-exercise steps 400 as previously mentioned in FIG. 2, may include step 401 (exercises selection) and step 402 (gameplay), and the step 402 of participant beginning the gameplay may further include step 402A (calibration) and step 402B (beginning a gameplay loop). For example, at step 401, the player 110 selects a therapeutic exercise from a list of available exercises previously inputted by the player's health care professional or clinician into the system 100. In embodiments, the step 401 may include step 202 and step 220 illustrated in FIG. 2. At step 402B, the player 110 receives an in-game prompt suggesting completing certain therapeutic exercises in a gamified manner (e.g., performing certain physical movements). These physical movements consist of various therapeutic exercises that enable recovery from musculoskeletal pathologies. Step 402B may include one or more exercise loops 410.

Referring to FIG. 4, an exercise loop 410 includes multiple steps may be performed after the completion of the pre-exercise steps 400. At step 411 (movement instruction), the participant is provided with a therapeutic exercise to complete. The game provides a demonstration of said movement in visual form. Additionally, on-screen text prompts encourage the participant to carry out the movement as demonstrated. All movements used in this step of gameplay were previously selected by their health care provider in step 401 (exercise selection). At step 412, the participant is then provided with a finite or predetermined amount of time to complete the therapeutic exercise as instructed. The rest of the exercise gameplay loop 410 may be restricted in time based on the therapeutic exercise suggested. At step 413 (pose estimation), a pose estimation algorithm tracks the cardinal joints of the body. This tracking is continuous, and monitors for movement in the participant's body. Any joint of the body can be tracked using an appropriate pose estimation algorithm. The game detects a change in a joint's position over time. This change in joint position is the core of the exercise gameplay loop 410. At step 414 (determination of success), the game defines a starting position and ending position of predetermined major joints for each exercise. The joint positions of interest are determined by the therapeutic exercise in question and included in information 222. For example, when flexing the elbow, the system tracks motion of the shoulder, elbow, and wrist. In some embodiments, for elbow flexion, the starting position may refer to a wrist marker being placed below the elbow marker (e.g., vertical axis of measurement), and the ending position may refer to a wrist marker being placed above the elbow marker and the distance from wrist to shoulder is less than the distance from wrist to elbow (i.e., the wrist has to be closer to the shoulder than it is to the elbow). In some embodiments, for shoulder rotation, the starting position may refer to the wrist being placed past the elbow which is placed past the shoulder in the horizontal plane, and the ending position may refer to the distance between wrists is less than half of the distance between shoulder points (i.e., the wrists need to be closer to each other than they are the shoulder). In accordance with the embodiments, all necessary information, or conditions to make a decision of exercise success is preloaded into the game in its current state.

In embodiments, step 414 of determination of movement success may use the following decision-making algorithm: (1) identify therapeutic exercise suggested to participant; (2) identify critical joints for determination of success; (3) perform all calculations based on relative joint position over time (As each participant may necessarily have a different body shape, absolute values for calculations cannot be used, instead, the system uses the relative position of cardinal joints over time. For example, in the elbow flexion example, the system calculates the position of the wrist relative to the elbow and the shoulder over time and the position of the elbow relative to the shoulder over time); (4) compare relative starting position of the cardinal joints to relative end position of the cardinal joints during the timeframe for therapeutic exercise completion; (5) if the starting and ending positions fall within pre-defined acceptable ranges, accept the participant's movement as successful (leading to character action at step 415A), otherwise failure (leading to character action at step 415B).

Step 415A and 415B also include performing a respective character action. In other words, the participant's character in the game then takes an action or a favourable action if a participant's movement was judged to be successful at step 414. In some embodiments, if the movement was not deemed successful at step 414, then no character action occurs or an unfavourable character action occurs. After step 415A or 415B, the participant is prompted to another exercise loop (e.g., starting over from step 411).

An aspect may include a therapeutic exercise tool including a therapeutic exercise selection step that allows a person skilled in the art of prescribing therapeutic exercise, such as a clinician, to assign appropriate therapeutic exercises to an individual in need of treatment (a participant). A motion capture device tracks the participant's movements throughout use of the system. The motion capture device may be connected to personal computer upon which the therapeutic exercise tool runs.

In an aspect, a personal computer that can run the therapeutic exercise tool.

In an aspect, a motion capture algorithm can be used to identify the position of the participant's body's joints throughout use of the device.

An aspect includes a method of delivering exercise instruction to the participant.

In an aspect, a mathematical model quantifies the relative position of the participant's joints to each other throughout use of the device. When certain thresholds for movement are met, the mathematical model classifies the participant's movements as successful.

In some embodiments, gameplay may be adaptive in the sense that the thresholds or criteria for determining successful movement may change over time. For example, if the participant has previously demonstrated that they can perform an expected motion to a predetermined level of fidelity, the threshold metrics for classifying the movements as successful may be made more stringent. If the participant begins performing the movements with less fidelity than was achieved previously, the threshold metrics may be relaxed.

In embodiments, the participant's joint positions are encoded as time series data or another type of data, indicating the spatial position of one or more joints of interest at one or more corresponding times. This data indicative of positions of joints and corresponding times (motion capture data) can be processed to determine how close they are to expected positions of joints and corresponding times, associated with successful performance of the exercise (expected motion data). The comparison can involve, for example, determining the mean square error between data points indicating the participant's joint positions at various times to data points indicating the ideal or expected joint positions at the various times. Various processing routines for measuring the difference between two data sets, such as two sets of time series data, can be used to compare motion capture data to expected joint positions.

In various embodiments, comparison can be made after a preprocessing step that includes, for example, compensating for non-critical differences between the motion capture data and the expected motion data. Such differences can include rotation of the motion capture data (e.g. indicative of a rotation of the camera or other sensing device), resizing of the motion capture data (e.g. indicative of a distance of the camera from the participant, physical sizing of the participant, or a combination thereof), or the like, or a combination thereof. In various embodiments, in addition to or alternatively to preprocessing, the processing to compare motion capture data and expected motion data can be inherently tolerant to such differences, for example due to the type of numerical comparisons and processing operations being used.

It is noted that there may be multiple reasons for an observed joint position to differ from an expected joint position. A first reason is due to the performance of motion capture equipment and computer processing operations determining joint position. A second reason is due to imperfect timing of motion by the participant. A third reason is due to imperfect spatial aspects of motion by the participant. According to embodiments, differences due to the first reason are suppressed or filtered out from the motion capture data to a given extent, while differences due to one or both of the second and third reason are relatively maintained in the motion capture data. In some embodiments, when timing is not critical to a given exercise, differences due to the second reason may be suppressed or filtered out at least to a given extent.

In an aspect, a video game character's action within the video game may be updated whenever the participant's movements are classified as successful.

In an aspect, the system may include a predetermined relative start position for the joints of the body based on the therapeutic exercise selected and have a predetermined relative end position for the joints of the body based on the therapeutic exercise selected. A threshold for a successful movement based on the change between the starting and ending position of the relative positions of the joints of the body may be used to determine success.

An aspect may include differing predetermined positions and thresholds depending on the therapeutic exercise selected.

In an aspect, the motion capture system may include a digital camera, a digital microphone, and a gyroscopic sensor attached to the participant's body.

In an aspect, the motion capture algorithm may rely on sensing techniques such as visual information from a live visual feed, which may or may not include sensing points anchored on the participant's body and clothing, gyroscopic information from a sensing device attached to the participant's body. The gyroscopic information may include limb position in space based on a fixed reference point, limb acceleration, limb velocity, joint rotational velocity, or joint rotational acceleration. Accordingly, instead of or in addition to capturing joint motion via video camera, joint movement can be captured using other position sensors. Various sensors can be used, such as position sensors attached to the body, or remote sensors other than a video camera. Examples of such remote sensors include ultrasonic sensors, Lidar sensors, object sensing using wireless signals (e.g. Wi-Fi™ signals) in a Radar fashion, or the like, or a combination thereof.

In some embodiments, participant may wear markers such as colored stickers or electromagnetic reflectors to facilitate position sensing and/or motion capture. The markers may be attached to areas of the body at or around joints of interest.

In an aspect force information may be obtained from a force plate or similar sensing device.

In an aspect, the system may include a video tutorial showing how to complete the selected therapeutic exercise, an audio tutorial describing how to complete the selected therapeutic exercise, or both a video tutorial and an audio tutorial.

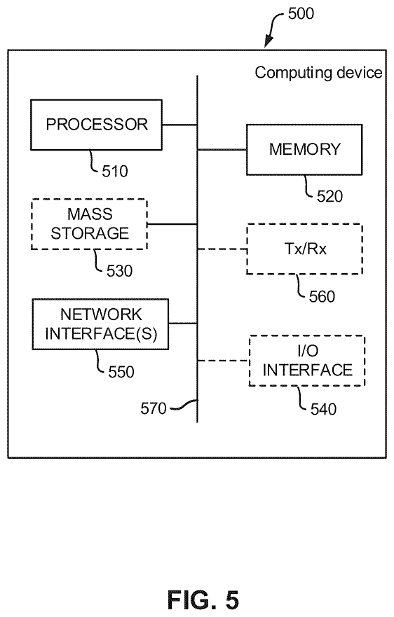

FIG. 5 illustrates a computing device 500 that may perform any or all of the steps of the above methods and features as described herein, according to different embodiments of the present disclosure. For example, personal computers, smartphones, laptops, tablets, kiosks, electronic book readers, gaming machine, media players, devices performing computing tasks, or other computing devices can be configured as the computing device 500. A system configured to perform embodiments of the present disclosure can include one or more computing devices for example as described in FIG. 5, or portions thereof.

As shown in FIG. 5, the device includes a processor 510, such as a Central Processing Unit (CPU) or specialized processors such as a Graphics Processing Unit (GPU) or other such processor unit, memory 520, non-transitory mass storage 530, I/O interface 540, network interface 550, and a transceiver 560, all of which are communicatively coupled via bi-directional bus 570. According to certain embodiments, any or all of the depicted elements may be utilized, or only a subset of the elements. Further, the device 500 may contain multiple instances of certain elements, such as multiple processors, memories, or transceivers. Also, elements of the hardware device may be directly coupled to other elements without the bi-directional bus.

The memory 520 may include any type of non-transitory memory such as static random-access memory (SRAM), dynamic random-access memory (DRAM), synchronous DRAM (SDRAM), read-only memory (ROM), any combination of such, or the like. The mass storage element 530 may include any type of non-transitory storage device, such as a solid-state drive, hard disk drive, a magnetic disk drive, an optical disk drive, USB drive, or any computer program product configured to store data and machine executable program code. According to certain embodiments, the memory 520 or mass storage 530 may have recorded thereon statements and instructions executable by the processor 510 for performing any of the aforementioned method steps described above.

A computing device configured in accordance with the present disclosure may comprise hardware, software, firmware, or a combination thereof. Examples of hardware are computer processors, signal processors, application-specific integrated circuits (ASICs), field programmable gate arrays (FPGAs), silicon photonic chips, etc. The hardware can be electronic hardware, photonic hardware, or a combination thereof. The computing device can be considered a computer in the sense that it performs operations that correspond to computations, e.g., receiving and processing signals indicative of image data, implementing a machine learning model such as a neural network model, updating parameters (weights) of the machine learning model, providing outputs of the machine learning model, etc. A machine learning model manager (e.g., a neural network manager) may be responsible for operating the machine learning model, for example by adjusting parameters thereof. The computing device can thus be provided using a variety of technologies as would be readily understood by a worker skilled in the art.

It may be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. For example, a first portion of the method may be performed using one computing device, and a second portion of the method may be performed using another computing device, server, or the like. In other words, the computer program product is a computer-readable medium upon which software code is recorded to execute the method when the computer program product is loaded into memory and executed on the microprocessor of the wireless communication device. The computer-readable medium may be non-transitory in the sense that the information is not contained in transitory, propagating signals.

Further, each step of the method may be executed on any real or virtual computing device, such as a personal computer, server, tablet, smartphone, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

To summarize the above aspects, embodiments of the present disclosure may provide various technical advantages or benefits. By converting real world movement into character control in a video game, it attempts to address one aspect of the adherence gap through play. By packaging exercise in a video game format, the game attempts to make therapeutic exercise enjoyable and fun.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for assessing the performance of an exercise, the method comprising:
receiving, from a user interface, a selection of an exercise;
reading, from a non-transitory memory, data associated with the exercise, the data including indications of a plurality of joints to detect and a plurality of expected positions of each of the plurality of joints;
receiving, from a video source, a plurality of frames of a performance of a user performing the exercise;
detecting each of the plurality of joints within each of the plurality of frames;
determining a change in positions of each of the plurality of joints over a timeframe corresponding to the plurality of frames;
determining that the performance was a success based on comparing the changes in positions of each of the plurality of joints to the plurality of expected positions of each of the plurality of joints over the timeframe; and
sending, to the user interface, an indication of success that the exercise was performed correctly.

2. The method of claim 1 wherein the plurality of expected positions of each of the plurality of joints includes relative positions between the plurality of expected positions of two of the plurality of joints.

3. The method of claim 2 wherein the comparing of the changes in positions of each of the plurality of joints to the plurality of expected positions of each of the plurality of joints over the timeframe includes comparing relative starting positions of each of the plurality of joints to relative ending positions of each of the plurality of joints.

4. The method of claim 1 further comprising:
displaying, on the user interface, in response to sending the indication of success, a movement of a character of a computer game.

5. The method of claim 4 wherein the movement of the character comprises moving the character between horizontal lanes displayed in the computer game.

6. The method of claim 5 further comprising:
displaying, on the user interface, objects within the lanes of the computer game that prompt the user to perform the exercise in order to move the character into a lane or out of a lane through a successful performance of the exercise.

7. The method of claim 1 wherein the plurality of joints to detect are selected from the group including a wrist, an elbow, and a shoulder.

8. The method of claim 1 wherein movement of each of the plurality of joints include a flexion movement or a rotational movement.

9. The method of claim 1, wherein movement of each of the plurality of joints include an elbow flexion or a shoulder rotation.

10. The method of claim 1, wherein determining that the performance was a success is based on information preloaded into the non-transitory memory.

11. A computing system comprising:
a processor; and
a non-transitory memory for storing instructions that when executed by the processor cause the computing system to be configured to:
receive, from a user interface, a selection of an exercise;
read, from the non-transitory memory, data associated with the exercise, the data including indications of a plurality of joints to detect and a plurality of expected positions of each of the plurality of joints;
receive, from a video source, a plurality of frames of a performance of a user performing the exercise;
detect each of the plurality of joints within each of the plurality of frames;
determine a change in positions of each of the plurality of joints over a timeframe corresponding to the plurality of frames;
determine that the performance was a success based on comparing the changes in positions of each of the plurality of joints to the plurality of expected positions of each of the plurality of joints over the timeframe; and
send, to the user interface, an indication of success that the exercise was performed correctly.

12. The computing system of claim 11, wherein the plurality of expected positions of each of the plurality of joints includes relative positions between the plurality of expected positions of two of the plurality of joints.

13. The computing system of claim 12 wherein the comparing of the changes in positions of each of the plurality of joints to the plurality of expected positions of each of the plurality of joints over the timeframe includes comparing relative starting positions of each of the plurality of joints to relative ending positions of each of the plurality of joints.

14. The computing system of claim 11 further configured to:
display, on the user interface, in response to sending the indication of success, a movement of a character of a computer game.

15. The method of claim 4 wherein the movement of the character comprises moving the character between horizontal lanes displayed in the computer game.

16. The computing system of claim 5 further configured to:
display, on the user interface, objects within the lanes of the computer game that prompt the user to perform the exercise in order to move the character into a lane or out of a lane through a successful performance of the exercise.

17. The computing system of claim 11 wherein the plurality of joints to detect are selected from the group including a wrist, an elbow, and a shoulder.

18. The method of claim 1 wherein movement of each of the plurality of joints include a flexion movement or a rotational movement.

19. The method of claim 1, wherein movement of each of the plurality of joints include an elbow flexion or a shoulder rotation.

20. A non-transitory computer readable medium having statements and instructions recorded thereon which, when executed by a computer, cause the computer to perform the method of claim 1.
